(19) United States
(12) Patent Application Publication
(10) Pub. No.: US 2026/0281612 A1
(43) Pub. Date: Sep. 17, 2026

(54) TRANSDUCER AND TRANSDUCER ARRAY

(71) Applicant: ROHM CO., LTD., Kyoto (JP)

(72) Inventor: Takashi NAIKI, Kyoto-shi (JP)

(73) Assignee: ROHM CO., LTD., Kyoto (JP)

(21) Appl. No.: 19/669,499

(22) Filed: May 6, 2026

Related U.S. Application Data
(63) Continuation of application No. PCT/JP2024/038726, filed on Oct. 30, 2024.

(30) Foreign Application Priority Data
Nov. 14, 2023 (JP) 2023-193801

(51) Int. Cl. H04R 1/34; H04R 1/28; H04R 1/40; H04R 7/04; H04R 7/18; H04R 17/00

(52) U.S. Cl. CPC H04R 1/345; H04R 1/2811; H04R 1/2888; H04R 1/40; H04R 7/04; H04R 7/18; H04R 17/00; H04R 2201/003

(57) ABSTRACT

A transducer includes a diaphragm capable of vibrating in a thickness direction, a driver that vibrates the diaphragm, and a lid placed over the diaphragm. The lid is formed with through-holes that allow an interior space formed between the lid and the diaphragm to communicate with an outside, thereby radiating sound waves from the diaphragm, which is a planar sound source, to the outside as a point or line sound sources. The sound waves from the point or line sound sources are combined by forming the through-holes in plural. With respect to a maximum value of a volume of air pushed out or drawn in from the interior space determined based on a vibration amplitude and a vibration frequency of the diaphragm, a width and a depth of the through-holes are set so that air having a volume equal to the maximum value can pass through at the vibration frequency.

### CROSS-REFERENCE TO RELATED APPLICATIONS

This is a continuation application (CA) of PCT Application No. PCT/JP2024/038726, filed on Oct. 30, 2024, which claims priority to Japan Patent Application No. P2023-193801 filed on Nov. 14, 2023, and is based upon and claims the benefit of priority from prior Japanese Patent Application No. P2023-193801 filed on Nov. 14, 2023 and PCT Application No. PCT/JP2024/038726, filed on Oct. 30, 2024, the entire contents of each of which are incorporated herein by reference.

### TECHNICAL FIELD

The present disclosure relates to a transducer and a transducer array.

### BACKGROUND

As a transducer that performs electro-acoustic conversion, a MEMS (Micro Electro Mechanical System) speaker has many advantages such as low power consumption, and has been widely used in recent years in earphones and the like.

### BRIEF DESCRIPTION OF DRAWINGS

FIG. 1 is a front view of a transducer according to a first embodiment.

FIG. 2 is a cross-sectional view taken along a cutting line II-II of FIG. 1.

FIG. 3 is a front view of a transducer according to a second embodiment.

FIG. 4 is a cross-sectional view taken along a cutting line IV-IV of FIG. 3.

FIG. 5 is a front view of a transducer according to a third embodiment.

FIG. 6 is a cross-sectional view taken along a cutting line VI-VI of FIG. 5.

FIG. 7 is a cross-sectional view schematically illustrating the structure of a transducer according to a fourth embodiment.

FIG. 8 is a schematic front view of a transducer array according to a fifth embodiment.

### DETAILED DESCRIPTION

Next, embodiments will be described with reference to the drawings. In the description of the drawings, the same or similar portions are denoted by the same or similar reference signs. However, it should be noted that the drawings are schematic and the relationship between the thickness and the planar dimensions of each component may differ from the actual dimensions. Therefore, specific thicknesses and dimensions should be determined in consideration of the following description. It is of course also noted that the drawings include portions where the dimensional relationships and ratios differ from one another.

The embodiments described below illustrate devices and methods for embodying technical ideas, and do not specify the material, shape, structure, arrangement, or the like of each component. The embodiments may be modified in various ways within the scope of the claims.

### First Embodiment

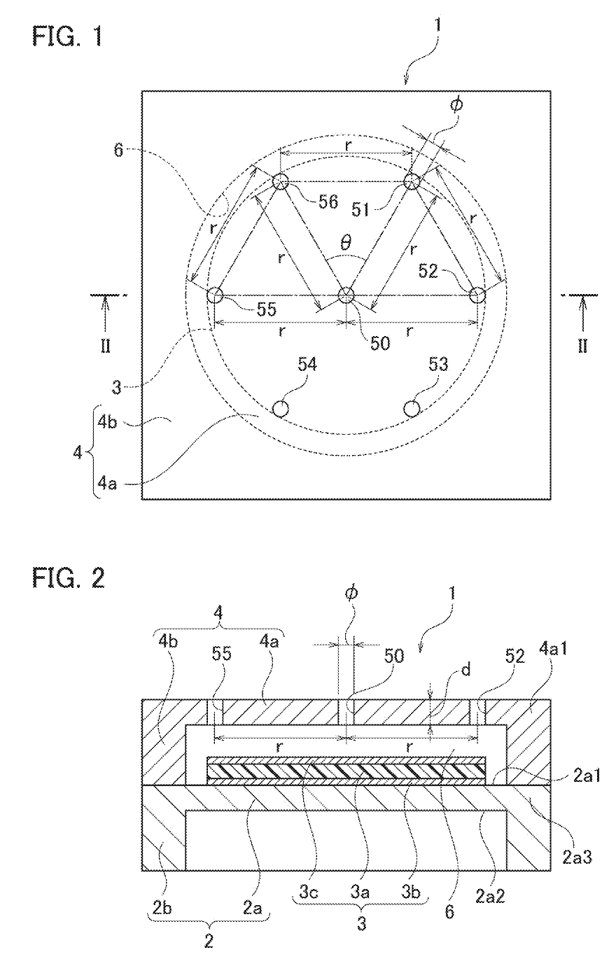

FIG. 1 is a front view of a transducer 1 according to a first embodiment, and FIG. 2 is a cross-sectional view schematically illustrating a structure of the transducer 1 of FIG. 1. FIG. 2 is a cross-sectional view taken along a cutting line II-II of FIG. 1. The transducer 1 according to the present embodiment performs electro-acoustic conversion by causing a driver such as a piezoelectric element 3 to vibrate a diaphragm 2a using electrical energy. The transducer 1 is actualized (commercialized) as a speaker, an earphone, or the like.

The transducer 1 includes the diaphragm 2a capable of vibrating in a thickness direction, a piezoelectric element 3 formed on a first surface 2a1 of the diaphragm 2a, and a first lid 4 placed over the diaphragm 2a.

The piezoelectric element 3 includes a piezoelectric film 3a and a pair of electrodes 3b and 3c formed on front and back surfaces of the piezoelectric film 3a. The piezoelectric film 3a is realized by ceramics formed by depositing PZT (lead zirconate titanate) using a sol-gel method or a sputtering method. In addition to PZT, aluminum nitride (AlN), zinc oxide (ZnO), lead titanate (PbTiO3), or the like may be used for the piezoelectric film 3a. Each of the pair of electrodes 3b and 3c is formed using, for example, a thin film of a conductive metal such as platinum, molybdenum, iridium, or titanium. The piezoelectric element 3 can be formed by depositing the electrode 3b, the piezoelectric film 3a, and the electrode 3c on the diaphragm 2a, and patterning them into a desired planar shape.

When a voltage is applied between the electrodes 3b and 3c, the piezoelectric film 3a contracts in a surface direction of the piezoelectric film 3a. The contraction of the piezoelectric film 3a causes the diaphragm 2a to receive stress in the surface direction and vibrate in the thickness direction. The vibration of the diaphragm 2a becomes vibration of air, and the transducer 1 can perform electro-acoustic conversion. The transducer 1 can constitute a MEMS speaker.

In the present embodiment, the piezoelectric element 3 is formed in a disk shape as viewed from the vibration direction of the diaphragm 2a, and the diaphragm 2a is a circular-type diaphragm. The piezoelectric element 3 is mounted on the first surface 2a1 of the diaphragm 2a.

The transducer 1 includes a vibrating portion 2. The diaphragm 2a is a part of the vibrating portion 2. The vibrating portion 2 further includes a plate support portion 2b that supports the diaphragm 2a. The plate support portion 2b is formed in a cylindrical shape, with the diaphragm 2a attached to one end thereof, and the other end configured as an open end. A space open to the other end side of the plate support portion 2b is formed inside the plate support portion 2b. The vibrating portion 2 can be formed from a semiconductor substrate such as silicon. For example, the diaphragm 2a and the plate support portion 2b can be integrally formed by etching a silicon substrate from the side facing the first surface 2a1 of the diaphragm 2a. With the plate support portion 2b, the diaphragm 2a is able to vibrate in the thickness direction. A MEMS speaker having a circular-type diaphragm in which the diaphragm 2a is displaceable in the thickness direction is highly versatile and can be manufactured at low cost, can be made structurally strong, and is suitable for use as a MEMS speaker.

Sound waves having opposite phase to those emitted from the first surface 2a1 are emitted from a second surface 2a2 of the diaphragm 2a, which opposes the first surface 2a1. The sound waves having opposite phase may be absorbed by a sound-absorbing material or the like, or may be reflected back to the first surface 2a1 side by a reflective material or the like to be in phase with the sound waves emitted from the first surface 2a1. Alternatively, the emission of sound waves having opposite phase may be reduced by preventing, through the use of a sealed space, the leakage of sound extracted to the back side of a mounting substrate via an opening formed in a mounting substrate (not illustrated) on which the transducer 1 is mounted. The mounting substrate is, for example, a printed board such as a printed wiring board (PWB) or a printed circuit board (PCB). The mounting substrate is also provided with wirings routed to the electrodes 3b and 3c, as well as a drive circuit or the like that applies voltage to the electrodes 3b and 3c via the wirings (both not illustrated).

The first lid 4 is placed over the diaphragm 2a. The first lid 4 is formed with a plurality (seven in FIG. 1) of through-holes 50, 51, 52, 53, 54, 55, and 56 (hereinafter collectively referred to as through-holes 5). The first lid 4 includes a plate-shaped first lid portion 4a and a first cylindrical portion 4b that connects an outer edge 4a1 of the first lid portion 4a to an outer edge 2a3 of the diaphragm 2a. In the present embodiment, the through-holes 5 are formed in the first lid portion 4a. The first lid 4 may be formed by laminating silicon thin plates processed with the through-holes 5, or by processing the through-holes 5 in a resin plate such as polycarbonate or a metal plate.

An interior space 6 is formed between the first lid 4 and the diaphragm 2a, and the interior space 6 communicates with the outside through the through-holes 5. The through-holes 5 are formed to have a predetermined small area that is smaller than the area of the diaphragm 2a as viewed from the vibration direction of the diaphragm 2a. This makes it possible for the through-holes 5 to radiate the sound waves from the diaphragm 2a, which is a planar sound source, to the outside as sound waves from a point sound source. That is, instead of the diaphragm 2a acting as a planar sound source, the through-holes 5 serve as new sound sources, namely point sound sources, and re-radiate the sound waves. Therefore, in the transducer 1 of the present embodiment, each through-hole 5 can be regarded as a minute point speaker.

By providing the plurality of through-holes 5, the transducer 1 of the present embodiment constitutes a speaker with a micro-array structure in which, while the diaphragm 2a is a single transducer, a plurality of point sound sources are provided and the sound waves radiating from the plurality of point sound sources can be combined. This allows the transducer 1 of the present embodiment to enhance directivity and output sound pressure level. That is, the transducer 1 of the present embodiment can propagate sound waves as plane waves within a certain width without inadvertently diffusing them.

Here, the through-holes 5 serving as the point sound sources will be described in detail. If the opening area of each through-hole 5 as viewed from the vibration direction of the diaphragm 2a is small, or if the number of through-holes 5 is small and the total area of the through-holes 5, that is, the predetermined small area described above is small, the air in the interior space 6 cannot be completely pushed out or drawn in during a half-cycle of the vibration of the diaphragm 2a. For this reason, the first lid 4 ends up functioning as a damper (buffer). That is, the volume of air corresponding to the stroke of the diaphragm 2a moving at one time is compressed or expanded at the speed (frequency) at which the diaphragm 2a moves. It is desirable that the through-holes 5 have a hole diameter and depth sufficient to reduce, within a predetermined time, that is, within the speed (frequency) at which the diaphragm 2a moves, the pressure difference with the outside generated by the compression and expansion through the flow of air to and from the outside.

Conversely, if the opening area of the through-holes 5 is large, or if the number of through-holes 5 is large and the total area of the through-holes 5 is large, the through-holes 5 merely pass through the sound from the diaphragm 2a as a planar sound source as is, and the effect of the through-holes 5 as point sound sources becomes poor. An example of such a case is a mesh-type speaker cover for dust protection or protection purposes. Furthermore, the thicker the first lid 4, the more effective it is in shielding the interior space 6 from the outside, and the more effective the through-holes 5 are as point sound sources. However, if the first lid 4 is thick, a depth d of the through-holes 5 becomes large, so the air that should be pushed out or drawn in does not pass through completely, stagnates inside the through-holes 5, and the through-holes 5 act as orifices (throttles). That is, the flow resistance of the through-holes 5 increases, and as a result, the through-holes 5 end up restricting the movement of the diaphragm 2a.

Therefore, in the present embodiment, with respect to the maximum value of the volume of air pushed out or drawn in from the interior space 6 determined based on the vibration amplitude and vibration frequency of the diaphragm 2a, the diameter and depth of each of the plurality of through-holes 50 to 56 are set so that air having a volume equal to the maximum value can pass through within a half-cycle at the vibration frequency corresponding to the maximum value. Specifically, the parameters are the viscosity of the filler (air), the area of the piston (diaphragm 2a), the speed of the piston (diaphragm 2a) (frequency and volume of sound waves), and the size (diameter, number, and hole depth) of the orifice (through-holes 5).

In order to satisfy the conditions as described above, three or more through-holes 5 may be formed in the first lid portion 4a of the first lid 4 at equal intervals from one another. In the example of FIG. 1, the number of through-holes 5 is seven, and the through-holes 5 include the through-hole 50 located at the center of the circular-type diaphragm 2a and the through-holes 51 to 56 located at the outer peripheral edge of the diaphragm 2a. The through-holes 50 to 56 are arranged at equal intervals r from one another. In the example of FIG. 1, the through-hole 50 and two circumferentially adjacent through-holes from the through-holes 51 to 56 are arranged at positions corresponding to the vertices of an equilateral triangle. Therefore, the through-holes 51 to 56 at the outer peripheral edge are also arranged at equal angular intervals of θ = 60° in the circumferential direction centered on the through-hole 50. In the example of FIG. 1, each through-hole 5 is illustrated as a round hole, but may be a polygonal hole. The through-holes 5 may also be arranged in a matrix rather than at the vertices of an equilateral triangle.

In general, sound waves from a point sound source spread in a spherical shape; however, by arranging three or more through-holes 5 at equal intervals r in the first lid portion 4a as described above, it is possible to propagate the sound waves in a form close to a plane wave. Therefore, within the reach of this plane wave, the sound can be heard in the same manner even at positions offset from directly in front of the transducer 1, and unnecessary sound leakage can be prevented outside the reach of the plane wave.

The width of each through-hole 5 is determined in consideration of the depth d of the through-hole 5. The depth d of each through-hole 5 is determined by the thickness of the first lid portion 4a. As one example, if the thickness of the first lid portion 4a is approximately 250 μm, which is sufficient for structural strength, and the width of each through-hole 5 is 20 μm or more, it becomes possible to extract the sound waves from the interior space 6, and each through-hole 5 can function as a point sound source as described above. When the through-holes 5 are round holes as in FIG. 1, the width indicates the diameter φ.

However, if the diameter φ of the through-holes 5 is too small, the through-holes 5 produce a damping effect that acts as a brake restricting the movement of the diaphragm 2a. Therefore, in order to avoid the damping effect, the diameter φ of the through-holes 5 should be 20 μm or more, for example 50 μm. At approximately 50 μm, the damping effect can be avoided, and the effect as a point sound source as described above can also be exhibited.

In the circular-type diaphragm 2a, the deflection is greater closer to the center, and the calculation of the volume of the interior space 6 can be accomplished by dividing the diaphragm 2a into small sections and summing, over all sections, the volume of air pushed out or drawn in by each small section in the state of maximum deflection. The through-holes 5 may be widened toward the outside (in the case of round holes as described above, the diameter is enlarged), that is, formed in a tapered shape. This makes it possible to obtain a horn effect and improve the straightness of the sound waves from the point sound sources.

### Second Embodiment

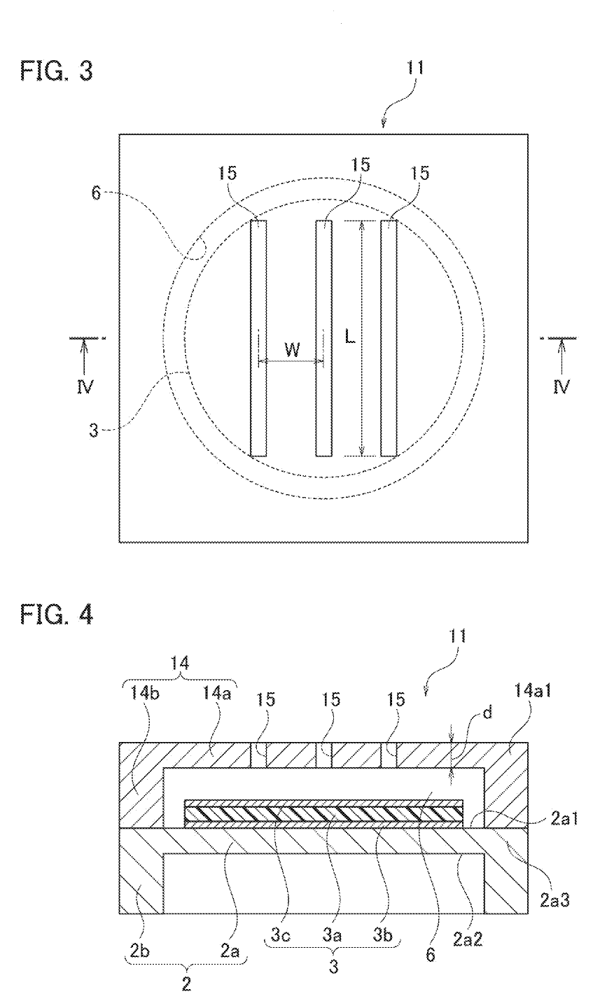

FIG. 3 is a front view of a transducer 11 according to a second embodiment, and FIG. 4 is a cross-sectional view schematically illustrating the structure of the transducer 11 of FIG. 3. FIG. 4 is a cross-sectional view taken along a cutting line IV-IV of FIG. 3. In the transducer 11 according to the present embodiment, the vibrating portion 2 and the piezoelectric element 3 are the same as those of the transducer 1 illustrated in FIGS. 1 and 2, and the structure of the first lid 14 placed over the diaphragm 2a differs.

The first lid 14 of the present embodiment includes a first lid portion 14a and a first cylindrical portion 14b that connects an outer edge 14a1 of the first lid portion 14a to the outer edge 2a3 of the diaphragm 2a. In the first lid 14 of the present embodiment, a plurality (three in FIGS. 3 and 4) of mutually parallel slits (elongated holes) are formed as through-holes 15. The first lid 14 may be formed, similarly to the first lid 4, by laminating silicon thin plates processed with the through-holes 15, or by processing the through-holes 15 in a resin plate such as polycarbonate or a metal plate.

In the transducer 11 configured in this manner, for a compact type such as a MEMS, if the air pressure inside the first lid 14 is considered to be uniform, the slit (elongated hole) through-holes 15 constitute a line sound source, and the same function as a line-array speaker in which point sound sources are linearly arranged, that is, one-dimensionally arranged without gaps, can be realized. A length L of the through-holes (slits) 15 is, for example, λ/4 (λ: wave length of a sound wave). In the case of a line sound source, the radiated sound normally spreads in a cylindrical manner. However, in the transducer 11 of the present embodiment, by arranging the slit (through-hole 15) line sound sources in parallel with each other at equal intervals W shorter than λ/4, the radiated sounds combine to increase straightness.

### Third Embodiment

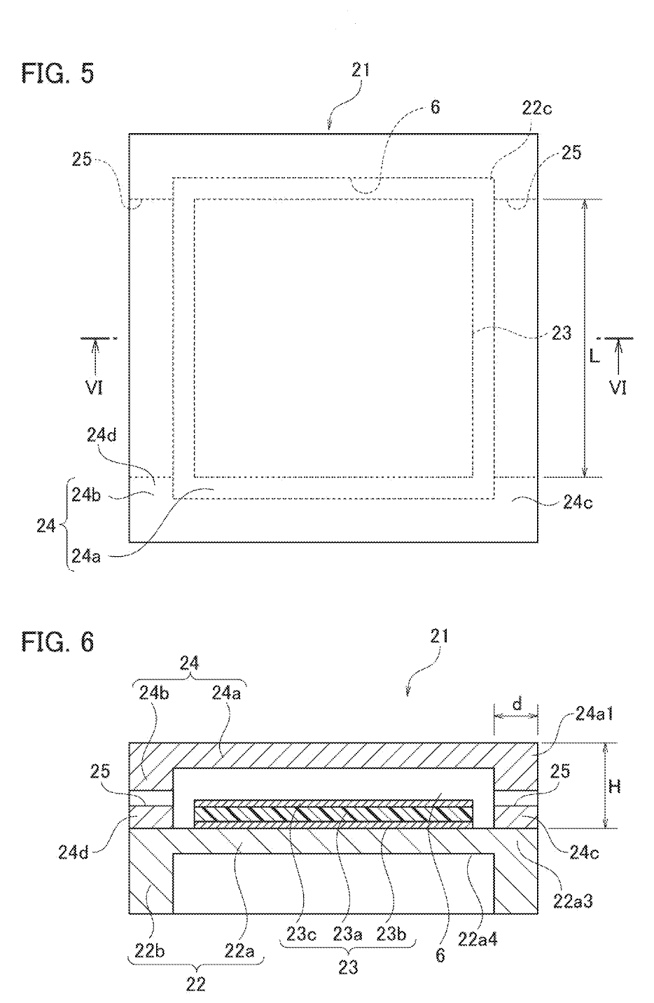

FIG. 5 is a front view of a transducer 21 according to a third embodiment, and FIG. 6 is a cross-sectional view schematically illustrating the structure of the transducer 21 of FIG. 5. FIG. 6 is a cross-sectional view taken along a cutting line VI-VI of FIG. 5.

In the transducer 21 of the present embodiment, the piezoelectric element 23 and the diaphragm 22a are formed in a rectangular shape as viewed from the vibration direction of the diaphragm 22a. The piezoelectric element 23 as a driver includes, similarly to the piezoelectric element 3 described above, a piezoelectric film 23a and a pair of electrodes 23b and 23c, the piezoelectric film 23a is interposed between the pair of electrodes 23b and 23c from the front and back surfaces. The vibrating portion 22, similarly to the vibrating portion 2 described above, is formed by etching silicon or the like, and includes a thin-plate diaphragm 22a and a plate support portion 22b depending from the outer peripheral edge thereof.

The first lid 24 includes a first lid portion 24a and a first cylindrical portion 24b that connects an outer edge 24a1 of the first lid portion 24a to an outer edge 22a3 of the diaphragm 22a. Corresponding to the piezoelectric element 23 and the diaphragm 22a formed in the rectangular shape, the first lid portion 24a is formed in a rectangular plate shape, and the first cylindrical portion 24b is formed in a square cylindrical shape. In the examples of FIGS. 5 and 6, the outer shape of the first lid portion 24a and the first cylindrical portion 24b as viewed from the vibration direction of the diaphragm 22a is a square. The inner circumferential shape of the first cylindrical portion 24b as viewed from the vibration direction of the diaphragm 22a is also a square.

The first lid 24 includes through-holes 25 that penetrate the first cylindrical portion 24b in a direction perpendicular to the vibration direction of the diaphragm 22a. The through-holes 25 are elongated holes (slits), and the longitudinal direction of the elongated holes is along the circumferential direction of the first cylindrical portion 24b. In the examples of FIGS. 5 and 6, the through-holes 25 are provided as a pair on two mutually facing wall surfaces 24c and 24d of the first cylindrical portion 24b, but the through-holes 25 may be formed on one, three, or all wall surfaces of the first cylindrical portion 24b. The number, shape, depth d, and length L of the through-holes 25 may be appropriately determined corresponding to the above-described maximum value of the volume of air pushed out or drawn in from the interior space 6.

Here, at the wave length λ (17.2 mm) of 20 kHz, which is the upper limit of audible sound, λ/4 is 4.3 mm, and at the wave length of 2 kHz, which is perceived as somewhat high-pitched by the ear, λ/4 is 10 times larger at 43 mm. On the other hand, in the case of a MEMS speaker, the height H of the first lid 24 forming a front chamber is extremely thin, on the order of several tens to 500 μm. For this reason, even if the through-holes 25, which serve as inlets and outlets for the air compressed or expanded by the diaphragm 22a, are provided in the first cylindrical portion 24b on the side surface of the first lid 24, the through-holes 25 can be considered as sound sources. Furthermore, by making the through-holes 25 elongated holes (slits), a line sound source can be constituted. Furthermore, by making the through-holes 25 elongated holes (slits) formed in the circumferential direction of the square cylindrical shaped first cylindrical portion 24b, it is possible to realize a long, straight line sound source. A similar effect can be obtained by linearly arranging a plurality of holes in place of the through-holes 25.

On the other hand, consider a combination of the first lid 24 including the square cylindrical shaped first cylindrical portion 24b capable of realizing the long, straight line sound source described above with the circular-type diaphragm 2a, such as the transducer of FIGS. 1 or 3, as the diaphragm 22a of the present embodiment. In this case, a large amount of unnecessary space would be generated at the peripheral portion (particularly at the corners of the square cylinder) 22c of the diaphragm 22a. If such unnecessary space exists, the pressure change in the interior space 6 generated by the vibration of the diaphragm 22a would be relieved. That is, when the diaphragm 22a is considered as a piston, there would be many gaps around its periphery, and the volume of air pushed out or drawn in through the through-holes 25 would be reduced.

Therefore, as in the present embodiment, the rectangular shaped diaphragm 22a is combined with the first lid 24 including the square cylindrical shaped first cylindrical portion 24b. This makes it possible to reduce the unnecessary space generated at the peripheral portion 22a4 of the diaphragm 22a and enhance the effect as a line sound source. Even when the circular diaphragm 2a illustrated in FIGS. 1 and 3 is combined with the first lids 4 and 14 having a cylindrical inner circumference, the unnecessary space can be similarly reduced and the effect as a point sound source or line sound source can be enhanced. Furthermore, by forming the through-holes 25 extending in the circumferential direction of the first cylindrical portion 24b, the long, straight line sound source described above can be realized.

The diaphragm 22a is not limited to the double-supported beam type, and may be of the cantilevered type. The circular-type diaphragm 2a described above may also be a voice coil type speaker using a permanent magnet and a coil. The through-holes 25 may be a plurality of round holes or polygonal holes arranged along the circumferential direction of the first cylindrical portion 24b, instead of elongated holes (slits). In this manner, a plurality of point sound sources arranged along the circumferential direction can be constituted. The plurality of round holes or polygonal holes can further enhance the effect as point sound sources by satisfying the same conditions as the through-holes 5 described above.

### Fourth Embodiment

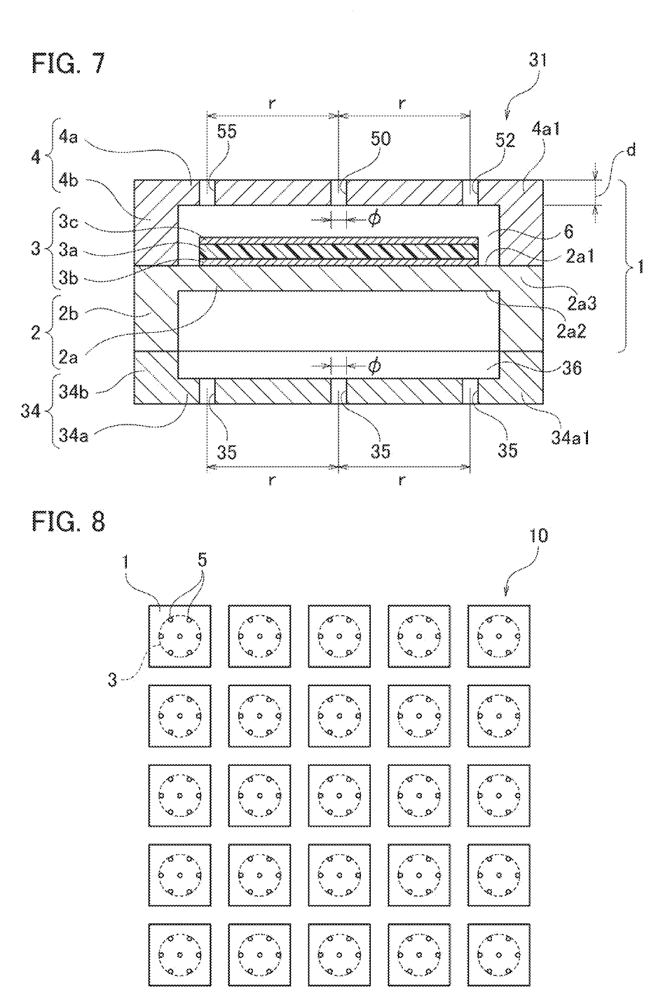

FIG. 7 is a cross-sectional view schematically illustrating the structure of a transducer 31 according to a fourth embodiment. The transducer 31 adds a second lid 34 to the transducer 1 illustrated in FIGS. 1 and 2. That is, in the transducer 31, the structures other than the second lid 34, specifically, the vibrating portion 2, the piezoelectric element 3, and the first lid 4, are the same as those of the transducer 1.

The second lid 34 includes a second lid portion 34a and a second cylindrical portion 34b that connects an outer edge 34a1 of the second lid portion 34a to an outer edge 2a3 (plate support portion 2b) of the diaphragm 2a. Seven through-holes 35 may be formed in the second lid portion 34a similarly to the through-holes 5 of FIG. 1. The through-holes 35 may be formed as slits (elongated holes) similarly to the through-holes 15 of FIG. 4. The second lid 34 may be formed, similarly to the first lids 4 and 14 of FIGS. 1-4, by laminating silicon thin plates processed with the through-holes 35, or by processing the through-holes 35 in a resin plate such as polycarbonate or a metal plate.

The piezoelectric element 3 is not provided on the second surface 2a2 of the diaphragm 2a. For this reason, the plate support portion 2b only needs to be formed to a height sufficient to absorb the stroke (vibration) of the diaphragm 2a. The second lid 34, which is placed over the second surface 2a2 side of the diaphragm 2a, may also be formed with the second cylindrical portion 34b as low as possible. This makes it possible to reduce the interior space 36 formed by the diaphragm 2a and the second lid 34, and to make it easier to extract the pressure change in the interior space 36 due to the vibration of the diaphragm 2a from the through-holes 35. In other words, by reducing the interior space 36, the effect of the through-holes 35 as point sound sources can be enhanced.

By configuring as described above, the transducer 31 can radiate sound waves from both sides of the diaphragm 2a using point sound sources or line sound sources. For this reason, the transducer 31 can further increase the output sound pressure level by adjusting the phase of the sound waves from either surface of the diaphragm 2a as appropriate and combining them with the sound waves from the other surface for radiation. Alternatively, for example, by radiating the sound waves from the first surface 2a1 of the diaphragm 2a forward through the first lid 4, and radiating the sound waves from the second surface 2a2 backward as they are through the second lid 34 while muffling them as necessary, an earphone or the like that prevents sound leakage to the surrounding environment can be realized. In that case, by forming the through-holes 35 in the second cylindrical portion 34b of the second lid 34, it is possible to radiate sound waves having opposite phase to the side of the earphone. Furthermore, by forming through-holes 35 in the second lid portion 34a and also forming through-holes 35 in the second cylindrical portion 34b, the sound around the earphone can be muffled more accurately, thereby preventing sound leakage.

It should be noted that the second lid 34 added to the transducer 31 need not be intended to obtain the above-described effect as a point sound source, but may function only as a damper to reduce unnecessary vibrations of the diaphragm 2a during resonance.

### Fifth Embodiment

FIG. 8 is a schematic front view of a transducer array 10 according to a fifth embodiment. The transducer array 10 is configured by arranging a plurality (5×5 in FIG. 8) of the transducers 1 illustrated in FIGS. 1 and 2 in an array. The transducer 11 illustrated in FIGS. 3 and 4 may also be used in the transducer array 10.

As described above, since each transducer 1 includes the plurality of through-holes 5 functioning as point sound sources, the radiated sound waves are combined. Further, a plurality of the transducers 1 are arranged linearly or in a plane (in a 5×5 plane arrangement in the example of FIG. 8) in the transducer array 10, so that it is possible to further enhance the directivity and output sound pressure level.

Here, in US 11,895,464 B2, a cylindrical substrate is placed over the front surface (acoustic radiation surface) of a MEMS speaker, and a baffle plate is further placed on top of that. In that patent, adjustment is performed so that the resonant frequency of the cavity formed by these members becomes the set frequency of the MEMS speaker. Furthermore, in that patent, by devising the shape of the through-holes formed in the baffle plate, the output sound pressure level at the set frequency is increased and harmonic distortion is adjusted.

However, in US 11,895,464 B2, the sound to be radiated is radiated as a planar sound source, which differs from the present embodiment.

The technical ideas that can be understood from the present disclosure are described in the following supplementary notes. The components described in the supplementary notes are given reference signs of corresponding components in the embodiments for the purpose of aiding understanding, not for the purpose of limitation. The reference numerals are given as examples to aid understanding, and the components described in each supplementary note should not be limited to the components indicated by the reference signs.

### Supplementary Note 1

The transducers 1, 11, 21, and 31 are transducers that perform electro-acoustic conversion, and include the diaphragm 2a or 22a capable of vibrating in a thickness direction, the driver (3, 23) that vibrates the diaphragm 2a or 22a by electrical energy, and the first lid 4, 14, or 24 placed over the diaphragm 2a or 22a. The first lids 4, 14, and 24 are formed with through-holes 5, 15, and 25 that allow the interior space 6 formed between the first lids 4, 14, and 24 and the diaphragms 2a and 22a to communicate with the outside, thereby radiating the sound waves from the diaphragms 2a and 22a, which are planar sound sources, to the outside as point or line sound sources. The sound waves from the point or line sound sources are combined by forming a plurality of the through-holes 5, 15, and 25. The width (diameter) φ and depth d of the plurality of through-holes 5, 15, and 25 are set with respect to the maximum value of the volume of air pushed out or drawn in from the interior space 6 determined based on the vibration amplitude and vibration frequency of the diaphragms 2a and 22a, so that air having a volume equal to the maximum value can pass through at the vibration frequency. The transducers 1, 11, 21, and 31 can enhance directivity and output sound pressure level by converting the planar sound source into a plurality of point or line sound sources and combining the radiated sound waves.

### Supplementary Note 2

In the transducers 1, 11, and 31 according to Supplementary Note 1, the first lids 4 and 14 include the first lid portions 4a and 14a facing the diaphragm 2a, and the first cylindrical portions 4b and 14b connecting the outer edges 4a1 and 14a1 of the first lid portions 4a and 14a to the outer edge 2a3 of the diaphragm 2a. The plurality of through-holes 5 and 15 are arranged in a planar or linear arrangement in the first lid portions 4a and 14a. The transducers 1, 11, and 31 can realize point or line sound sources by the through-holes 5 and 15 formed in the first lid portions 4a and 14a.

### Supplementary Note 3

In the transducer 21 according to Supplementary Note 1, the first lid 24 includes the first lid portion 24a facing the diaphragm 22a, and the first cylindrical portion 24b connecting the outer edge 24a1 of the first lid portion 24a to the outer edge 22a3 of the diaphragm 22a. The plurality of through-holes 25 are linearly arranged in the first cylindrical portion 24b. The transducer 21 can realize a line sound source that emits sound from the side surface.

### Supplementary Note 4

In the transducer 31 according to any one of Supplementary Notes 1 to 3, the first lids 4, 14, and 24 are placed over the diaphragms 2a and 22a, facing the first surface 2a1 thereof. The transducer 31 further includes the second lid 34 placed over the diaphragms 2a and 22a, facing the second surface 2a2 thereof on the opposite side from the first surface 2a1. The transducer 31 can radiate sound waves from both sides of the diaphragms 2a and 22a using point or line sound sources. For this reason, by appropriately attenuating or phase-adjusting the sound waves from the second surface 2a2 side of the diaphragms 2a and 22a, and radiating them to the surrounding environment or backward, it is possible to realize an earphone or the like that prevents sound leakage. Note that the second lid 34 may include the second lid portion 34a facing the diaphragms 2a and 22a, and the second cylindrical portion 34b connecting the outer edge of the second lid portion 34a to the outer edges 2a3 of the diaphragms 2a and 22a. The plurality of through-holes 35 may be arranged in a planar or linear arrangement in the second lid portion 34a.

### Supplementary Note 5

In the transducers 1, 11, 21, and 31 according to any one of Supplementary Notes 1 to 4, the driver is the piezoelectric element 3 or 23. In the transducers 1, 11, 21, and 31 that perform electro-acoustic conversion, the piezoelectric elements 3 and 23 as drivers for the diaphragms 2a and 22a are suitable because they have high energy conversion efficiency and a simple mechanical structure, and can provide greater power (output sound pressure level) compared to capacitive elements.

### Supplementary Note 6

In the transducers 1, 11, 21, and 31 according to Supplementary Note 5, the piezoelectric elements 3 and 23 include the piezoelectric films 3a and 23a and pairs of the electrodes 3b, 3c, 23b, and 23c formed on the front and back surfaces of the piezoelectric films 3a and 23a. The transducers 1, 11, 21, and 31 can be manufactured with a simple structure at low cost. In addition, the volume of air pushed out or drawn in by the transducers 1, 11, 21, and 31 can be increased, thereby increasing the volume of sound of the transducers 1, 11, 21, and 31.

### Supplementary Note 7

In the transducers 1, 11, 21, and 31 according to Supplementary Note 5 or Supplementary Note 6, the driver (3, 23) is a MEMS. Although transducers with a MEMS structure can be easily manufactured using semiconductor manufacturing technology and are extremely small and have many advantages such as low power consumption, their output sound pressure level is low. For this reason, the transducers 1, 11, 21, and 31, which as described above have a large effect of improving the output sound pressure level, are suitable for transducers with a MEMS structure.

### Supplementary Note 8

In the transducers 1, 11, and 31 according to Supplementary Note 2, the number of through-holes 5 is three or more, and the through-holes 5 are formed at equal intervals r from one another in the first lid portion 4a. The transducers 1, 11, and 31 can propagate sound waves in a form relatively close to plane waves.

### Supplementary Note 9

In the transducers 1 and 31 according to any one of Supplementary Notes 1 to 8, the diaphragm 2a is a circular-type diaphragm. The transducers 1 and 31 can be manufactured at low cost as general-purpose MEMS speakers or the like, and can also be made structurally strong.

### Supplementary Note 10

In the transducer 21 according to Supplementary Note 3, the diaphragm 22a has a rectangular shape as viewed from the vibration direction, the first lid portion 24a has a rectangular shape as viewed from the vibration direction, the first cylindrical portion 24b has a square cylindrical shape, and the through-holes 25 are formed linearly in the first cylindrical portion 24b to extend in the circumferential direction. The transducer 21 can reduce the unnecessary space generated at the peripheral portion 22c of the diaphragm 22a and enhance the effect as a line sound source. Furthermore, by forming the through-holes 25 extending in the circumferential direction of the first cylindrical portion 24b, a long, straight line sound source can be realized.

### Supplementary Note 11

In the transducer 1 according to any one of Supplementary Notes 1 to 10, the through-holes 5 are widened toward the outside. The transducer 1 can obtain a horn effect and improve the straightness of the sound waves from the point sound sources.

### Supplementary Note 12

In the transducer array 10, a plurality of the transducers 1, 11, 21, and 31 according to any one of Supplementary Notes 1 to 11 are arranged linearly or in a plane. The transducer array 10 can further enhance directivity and output sound pressure level.

The present disclosure has been described above in detail. However, it is obvious to a person skilled in the art that the present disclosure is not limited to the embodiment described above. One or more elements of one embodiment may be combined with one or more elements of another embodiment. Variations and modifications may be made to the present disclosure without departing from the spirit and scope of the present disclosure defined by the claims. Thus, the present disclosure described above is for illustrative purpose and is not intended to limit the present disclosure.

1. A transducer that performs electro-acoustic conversion, comprising:
a diaphragm capable of vibrating in a thickness direction;
a driver that vibrates the diaphragm by electrical energy; and
a first lid placed over the diaphragm, wherein
the first lid is formed with through-holes that allow an interior space formed between the first lid and the diaphragm to communicate with an outside, thereby radiating sound waves from the diaphragm, which is a planar sound source, to the outside as a point or line sound source,
the sound waves from the point or line sound source are combined by forming the through-holes in plural, and
with respect to a maximum value of a volume of air pushed out or drawn in from the interior space determined based on a vibration amplitude and a vibration frequency of the diaphragm, a width and a depth of the plurality of through-holes are set so that air having a volume equal to the maximum value can pass through at the vibration frequency.

2. The transducer according to claim 1, wherein
the first lid comprises a first lid portion facing the diaphragm, and a first cylindrical portion connecting an outer edge of the first lid portion to an outer edge of the diaphragm, and
the plurality of through-holes are arranged in a planar or linear arrangement in the first lid portion.

3. The transducer according to claim 1, wherein
the first lid comprises a first lid portion facing the diaphragm, and a first cylindrical portion connecting an outer edge of the first lid portion to an outer edge of the diaphragm, and
the plurality of through-holes are linearly arranged in the first cylindrical portion.

4. The transducer according to claim 1, wherein
the first lid is placed over the diaphragm, facing a first surface thereof, and
the transducer further comprises a second lid placed over the diaphragm, facing a second surface thereof on an opposite side from the first surface.

5. The transducer according to claim 1, wherein the driver is a piezoelectric element.

6. The transducer according to claim 5, wherein the piezoelectric element includes a piezoelectric film and a pair of electrodes formed on front and back surfaces of the piezoelectric film.

7. The transducer according to claim 5, wherein the driver is a MEMS.

8. The transducer according to claim 2, wherein the number of the through-holes is three or more, and the through-holes are formed at equal intervals from one another in the first lid portion.

9. The transducer according to claim 1, wherein the diaphragm is a circular-type diaphragm.

10. The transducer according to claim 3, wherein
the diaphragm has a rectangular shape as viewed from a vibration direction,
the first lid portion has a rectangular shape as viewed from the vibration direction,
the first cylindrical portion has a square cylindrical shape, and
the through-holes are formed linearly in the first cylindrical portion to extend in a circumferential direction.

11. The transducer according to claim 1, wherein the through-holes are widened toward the outside.

12. A transducer array, comprising:
a plurality of transducers that perform electro-acoustic conversion, wherein
each of the plurality of transducers comprises a diaphragm capable of vibrating in a thickness direction, a driver that vibrates the diaphragm by electrical energy, and a first lid placed over the diaphragm,
the first lid is formed with through-holes that allow an interior space formed between the first lid and the diaphragm to communicate with an outside, thereby radiating sound waves from the diaphragm, which is a planar sound source, to the outside as a point or line sound source,
the sound waves from the point or line sound source are combined by forming the through-holes in plural,
with respect to a maximum value of a volume of air pushed out or drawn in from the interior space determined based on a vibration amplitude and a vibration frequency of the diaphragm, a width and a depth of the plurality of through-holes are set so that air having a volume equal to the maximum value can pass through at the vibration frequency, and
the plurality of transducers are arranged in a planar or linear arrangement.
